(19) United States
(12) Patent Application Publication
(10) Pub. No.: US 2002/0097876 A1
(43) Pub. Date: Jul. 25, 2002

(54) Communication methods, communication systems and to personal communication devices

(76) Inventor: Keith Alexander Harrison, Monmouthshire (GB)

Correspondence Address: HEWLETT-PACKARD COMPANY, Intellectual Property Administration, P.O. Box 272400, Fort Collins, CO, 80527-2400, US

(21) Appl. No.: 10/023,887

(22) Filed: Dec. 21, 2001

(30) Foreign Application Priority Data
Dec. 22, 2000 (GB) 0031428.6

(51) Int. Cl. H04L 9/00

(52) U.S. Cl. 380/270; 380/277

(57) ABSTRACT

A communication method comprising a personal communication device (2), the personal communication device comprising a memory (8) in which is stored a secret, and a digital device (16) capable of communication with the personal communication device (2), the method comprising the steps of establishing communication between the personal communication device (2) and the digital device (16), and providing the secret from the personal communication device (2) to the digital device (16).

The present invention relates to communication methods, communication systems and to personal communication devices.

The advance of digital technology has meant that more and more transactions and communications are being carried out in the digital domain. One of the main concerns of users of this technology is that of security. One way in which security can be enhanced is by the provision of password protection for a user, for instance, to access their computer at work or their bank account. In the digital domain these passwords can be of a length and complexity such that it is impractical for a user to seek to memorise them themselves. Typically a digital password will be 16-20 bytes in length and random. The problem therefore arises of in which location to keep these passwords where they can be used and yet also be secure.

Preferred embodiments of the present invention aim to provide a solution to the problem outlined above.

To solve this problem the present invention proposes that secrets (which can include passwords) be kept in a user's personal communication device that is configured to provide the secret when required to do so. The user can have varying degrees of control over the automation of the provision of the secret when requested by an external source.

According to the present invention in a first aspect, there is provided a communication method comprising a personal communication device, the personal communication device comprising a memory in which is stored a secret, and a digital device capable of communication with the personal communication device, the method comprising the steps of establishing communication between the personal communication device and the digital device, and providing the secret from the personal communication device to the digital device.

Suitably, the communication established is wireless communication.

Suitably, the secret is encrypted in the memory and the method includes the step of decrypting the secret. Suitably, the secret is encrypted according to a key provided by the digital device.

Suitably, the method comprises the step of providing the secret to a designated digital device upon a user request.

Suitably, the method further comprises the steps of the digital device requesting a secret from the personal communication device, the personal communication device requesting confirmation from a user that the secret can be provided and providing the secret to the digital device only if the confirmation is provided by the user. Suitably, the confirmation comprises the user providing a secret. Suitably, the requesting step comprises the digital device and the personal communication device establishing contact with each other and the personal communication device indicating to the user that a request for a secret has been received. Suitably, the indicating step comprises providing an audible signal. Suitably, the indicating step comprises providing a visual signal. Suitably, the requesting step comprises providing to the user a selection of options of which at least one is to approve the request by selecting the relevant option.

Suitably, the memory stores a plurality of secrets and the method further comprises the step of the personal communication device providing a user with a plurality of secrets from which to select the secret to be provided to the digital device.

Suitably, the personal communication device comprises a cellular communication device. Suitably, the personal communication device comprises a cellular telephone for voice calls.

Suitably, the digital device is a non-cellular device. Suitably, the digital device comprises a modem for communication with the personal communication device.

A secret comprises information for authentication or authorisation that the user does not wish to become widely known.

According to the present invention in a second aspect, there is provided a communication system comprising a personal communication device, the personal communication device comprising a memory in which is stored a secret, and a digital device capable of communication with the personal communication device, the personal communication device being configured to transmit the secret when instructed to do so.

Suitably, the communication capable of being established between the personal communication device and the digital device is wireless communication.

Suitably, the secret is encrypted in the memory and the digital device is capable of decrypting the secret. Suitably, the secret is encrypted according to a key provided by the digital device.

Suitably, the personal communication device is configured whereby the secret is transmitted to a designated digital device upon receipt of a user instruction.

Suitably, the personal communication device is configured whereby upon the digital device requesting a secret from the personal communication device, the personal communication device requests confirmation from a user that the secret can be provided and provides the secret to the digital device only if the confirmation is provided by the user. Suitably, the confirmation comprises the user providing a secret. Suitably, to request the secret, the digital device is configured to establish contact with the personal communication device and the personal communication device is configured to indicate to the user that a request for a secret has been received. Suitably, the indication comprises providing an audible signal. Suitably, the indication comprises providing a visual signal. Suitably, the personal communication device is configured whereby upon receipt of the request the personal communication device provides to the user a selection of options of which at least one is to approve the request by selecting the relevant option.

Suitably, the memory stores a plurality of secrets and the personal communication device is configured to provide a user with a plurality of secrets from which to select the secret to be provided to the digital device.

Suitably, the personal communication device comprises a cellular communication device. Suitably, the personal communication device comprises a cellular telephone for voice calls.

Suitably, the digital device is a non-cellular device. Suitably, the digital device comprises a modem for communication with the personal communication device.

According to the present invention in a third aspect, there is provided a personal communication device, the personal communication device comprising a memory in which is stored a secret, the personal communication device being configured to transmit the secret to a digital device when instructed to do so.

Suitably, the transmission is by wireless communication.

Suitably, the secret is encrypted in the memory. Suitably, the secret is encrypted according to a key provided by the digital device.

Suitably, the personal communication device is configured to transmit the secret to a designated digital device upon receipt of a user instruction.

Suitably, the personal communication device is configured whereby upon receipt of a request for a secret from the personal communication device, the personal communication device requests confirmation from a user that the secret can be provided and transmits the secret only if the confirmation is provided by the user. Suitably, the confirmation comprises the user providing a secret. Suitably, the personal communication device is configured whereby upon receipt of a request for a secret, the personal communication device indicates to the user that a request for a secret has been received. Suitably, the indication comprises providing an audible signal. Suitably, the indication comprises providing a visual signal. Suitably, the personal communication device is configured whereby the user is provided with a selection of options of which at least one is to approve the request by selecting the relevant option.

Suitably, the memory stores a plurality of secrets and the personal communication device is configured to provide a user with a plurality of secrets from which to select the secret to be transmitted.

Suitably, the personal communication device comprises a cellular communication device. Suitably, the personal communication device comprises a cellular telephone for voice calls.

The present invention can be particularly beneficial because it enables a cellular mobile phone to transmit a secret stored on-board to a non-cellular device to enable the latter to perform a function, such as permitting user log-on or to complete a transaction.

Mobile phones are regarded as everyday personal items by their users who, as a rule, are used to treating them as valuable objects. Mobile phones are already provided with security devices such as Personal Identification Numbers (PIN) to prevent unauthorised access. Other biometric (e.g. fingerprint) security devices can be used if desired. Further, if the secrets are stored in the Subscriber Identity Module (SIM) card, they are transportable from phone to phone.

The present invention will now be described, by way of example only, with reference to the drawings that follow; in which:

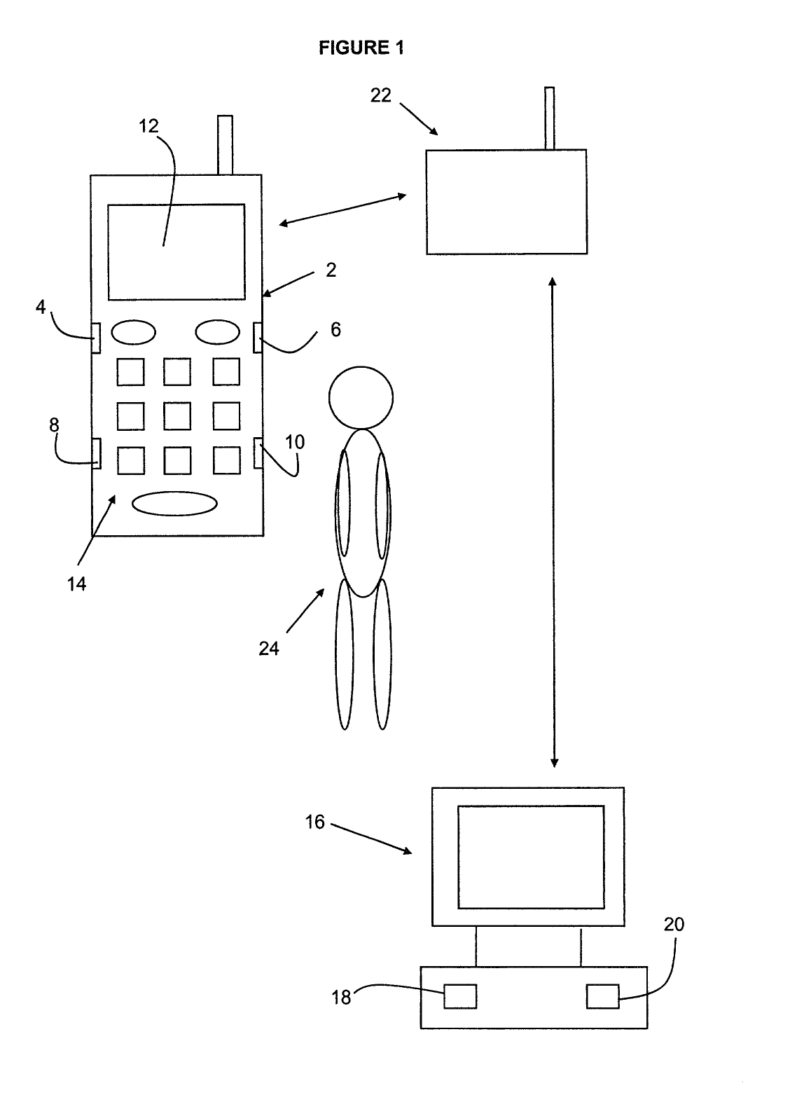

FIG. 1 is a diagram illustrating a first embodiment of the present invention.

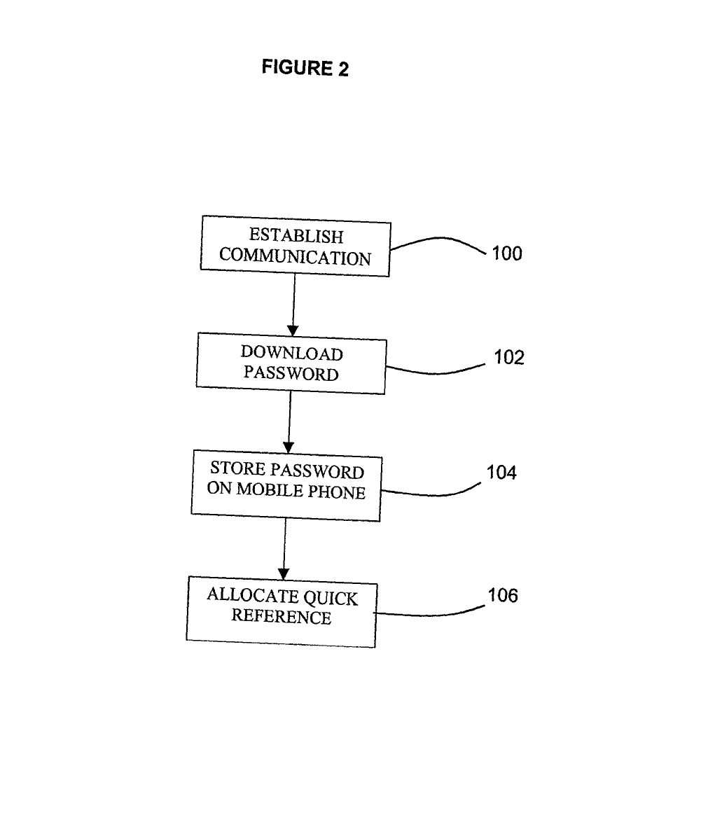

FIG. 2 is a functional flow diagram illustrating part of the operation of an embodiment of the present invention.

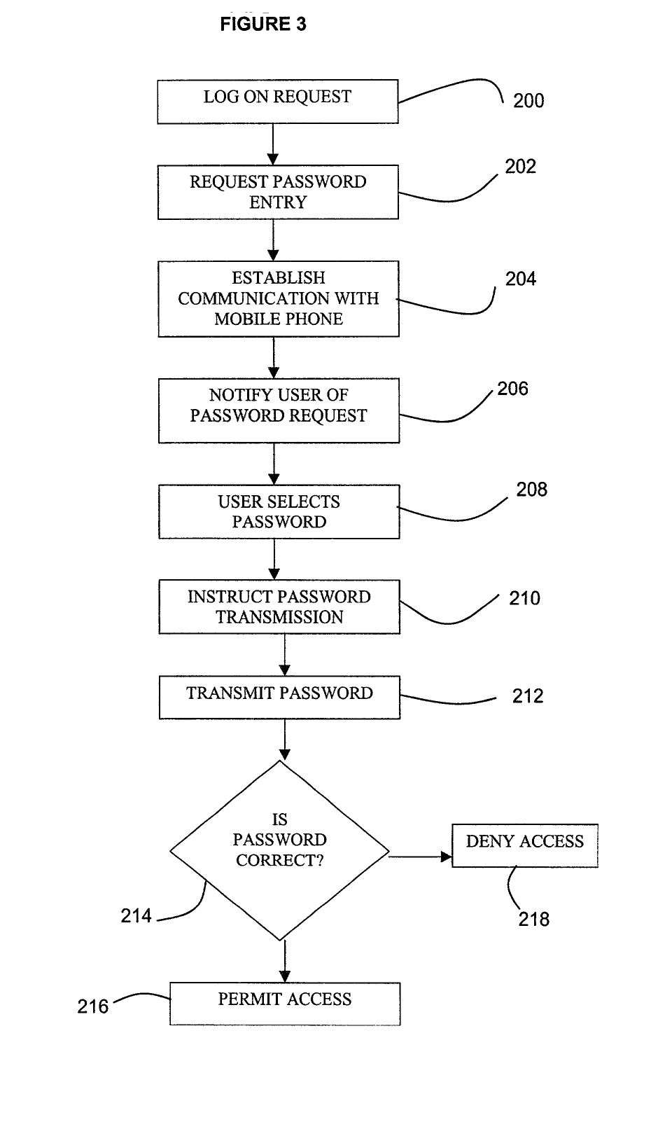

FIG. 3 is a functional flow diagram illustrating another part of the operation of an embodiment of the present invention corresponding to FIG. 2.

Referring to FIG. 1 of the drawings that follow, there is shown schematically a cellular digital mobile phone 2, being a personal communication device, comprising as is well known a radio transmitter 4, a radio receiver 6, a microprocessor 8 (including Random Access Memory (RAM)) and a SIM card 10. The phone 2 includes a liquid crystal display screen 12 and an alphanumeric keypad 14 as is well known in the art.

Also shown in FIG. 1 is a digital personal computer (PC) 16 comprising a PC modem 18 and a PC microprocessor 20.

Mobile phone 2 can establish radio communication with a cellular base station 22 via its radio transmitter 4 and receiver 6. Cellular base station 22 can establish communication with PC 16 via PC modem 18 using Wireless Application Protocol (WAP).

Operation of the system shown in FIG. 1 will now be described with reference to FIG. 2 of the drawings that follow using the example of a user 24 wishing to obtain and use a secret password to log on to their PC 16.

First the user 24 needs to obtain their password. To do so the mobile phone 2 and the PC 16 establish wireless communication with each other in step 100. This can be either by the user 24 instructing the mobile phone 2 to contact the PC 16 for a password or the PC 16 contacting the mobile phone 2 to provide a password.

Upon communication being established, the user 24 has a password downloaded to their mobile phone 2 in step 102. In this case it is the password for access to the PC 16. Generally this will be associated with a user name as is well known in the art.

The password is then stored in the mobile phone 2 in step 104. The password can be stored in the memory of microprocessor 8 or in the SIM card 10.

The user 24 then in step 106 allocates to the password a quick reference descriptor using the alphanumeric keypad 14 on the mobile phone 2. For instance the descriptor in this case may be “WORK PC PASSWORD”.

Referring now to FIG. 3 of the drawings that follow, use of the mobile phone 2 to access the PC 16 will now be described.

The user first notifies the PC 16 that he/she wishes to log on in step 200. Typically to do so the user will enter their user name in to the PC 16. The PC log on protocol is modified to require or permit password input from the user's mobile phone 2. At step 202, the PC then requests that the user's password be entered. The PC 16 establishes in step 204 communication with the mobile phone 2 by the calling the number of the mobile phone 2 from a look-up table. Alternatively, the user 24 can be prompted by the PC 16 to establish communication with the PC 16 from their mobile phone 2.

The user 24 is then in step 206 notified by an audible signal from their mobile phone 2 combined with an onscreen message on their mobile phone 2 that the PC password is being requested. Simultaneously a list of available passwords or other secrets in the mobile phone 2 is presented to the user on the screen 12 of the mobile phone 2 as a scroll down list. The passwords and other secrets are displayed by their quick reference descriptor titles.

In this case the user 24 selects “WORK PC PASSWORD” in step 208 and presses the “send” (or some other confirmatory) button on the mobile phone 2 in step 210. The PC digital password is then transmitted from the mobile phone to the PC 16 in step 212 via the cellular network. Upon receipt the PC 16 verifies the password (in step 214) and permits access (i.e. allows user log on) to the PC by the user 24 if the password is correct in step 216. If the password is incorrect, access is denied (step 218), a corresponding message is displayed on the PC 16 and transmitted by the PC 16 for display on the mobile phone screen 12.

As an option the user 24 may select that some or all of the secrets on the mobile phone 2 are transmitted automatically without the need for a confirmatory step by the user. In that case upon request from an external source, the mobile phone 2 will automatically provide the requested secret. Alternatively, the user 24 may transmit a secret upon request to a designated digital device, the device being designated by a number in the telephone network.

The password stored in the mobile phone can be encrypted. There are two reasons for encryption. The first is to prevent the password being made available to a thief. In this case the user must enter a password or other secret (typically via the keypad 14) before the password is transmitted. The password is verified by the mobile phone 2 before transmitting the secret. The second reason is to prevent the password from being made available to an eavesdropper. In this case the PC 16 sends a challenge, typically a digital key, which the mobile phone 2 uses to encrypt the password and send it to the PC 16 which decrypts the encrypted password. A nonce is used to prevent a reply attack.

The system described above is implemented using the Wireless Application Protocol (WAP).

The password may come from other sources. For instance the user 24 may be provided with the password already stored on a SIM 10 supplied with their phone or provided subsequently. Alternatively a secret may be loaded on to the phone by a trusted third party. If the user 24 downloads their own password there may be a requirement for them to be supervised to prevent mis-use.

Other examples of secrets that may be stored on the mobile phone are: public keys (for a public key infrastructure), symmetric keys such as a DES key, a PIN etc.

The present method, system and device can be used in other applications. For instance, if a bank wishes to confirm a transaction with a customer (here the user 24), it can send a message to the customer for instance using the Short Messaging Service (SMS) giving details of the transaction and requesting an authentication from the customer which he/she can provide in the form of a secret.

Whilst in preferred embodiments of the present invention all communication between the personal communication device and the digital device is using the cellular network, additional communication channels can be used such as infra-red communication.

The personal communication device may keep a log of all requests as a personal audit trail.

While the term password is used in this description, it need not be a word. It can be a key.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extend to any novel one, or any novel combination, of the features disclosed in this specification (including any accompanying claims, abstract and drawings), or to any novel one, or any novel combination, of the steps of any method or process so disclosed.

1. A communication method for a communication system comprising a personal communication device, the personal communication device comprising a memory in which is stored a secret, and a digital device capable of communication with the personal communication device, the method comprising the steps of establishing communication between the personal communication device and the digital device, the digital device requesting a secret from the personal communication device, the personal communication device requesting confirmation from a user that the secret can be provided and providing the secret to the digital device only if the confirmation is provided by the user.

2. A communication method according to claim 1, in which the communication established is wireless communication.

3. A communication method according to claim 1, in which the secret is encrypted in the memory and the method includes the step of decrypting the secret.

4. A communication method according to claim 3, in which the secret is encrypted according to a key provided by the digital device.

5. A communication method according to claim 1, in which the confirmation comprises the user providing a secret.

6. A communication method according to claim 1, in which the requesting step comprises the digital device and the personal communication device establishing contact with each other and the personal communication device indicating to the user that a request for a secret has been received.

7. A communication method according to claim 6, in which the indicating step comprises providing an audible signal.

8. A communication method according to claim 6, in which the indicating step comprises providing a visual signal.

9. A communication method according to claim 1, in which the requesting step comprises providing to the user a selection of options of which at least one is to approve the request by selecting the relevant option.

10. A communication method according to claim 1, in which the memory stores a plurality of secrets and the method further comprises the step of the personal communication device providing a user with a plurality of secrets from which to select the secret to be provided to the digital device.

11. A communication method according to claim 1, in which the personal communication device comprises a cellular communication device.

12. A communication method according to claim 11, in which the personal communication device comprises a cellular telephone for voice calls.

13. A communication method according to claim 1, in which the digital device is a non-cellular device.

14. A communication method according to claim 13, in which the digital device comprises a modem for communication with the personal communication device.

15. A communication method for a communication system comprising a personal communication device, the personal communication device comprising a memory in which is stored a secret, and a digital device capable of communication with the personal communication device, the method comprising the steps of establishing communication between the personal communication device and the digital device, the digital device requesting a secret from the personal communication device, the personal communication device requesting confirmation from a user that the secret can be provided by the digital device and the personal communication device establishing contact with each other and the personal communication device indicating to the user that a request for a secret has been received and providing the secret to the digital device only if the confirmation is provided by the user.

16. A communication method for a communication system comprising a personal communication device, the personal communication device comprising a memory in which is stored a secret, and a digital device capable of communication with the personal communication device, the method comprising the steps of establishing communication between the personal communication device and the digital device, the digital device requesting a secret from the personal communication device, the personal communication device requesting confirmation from a user that the secret can be provided by providing to the user a selection of options of which at least one is to approve the request by selecting the relevant option and providing the secret to the digital device only if the confirmation is provided by the user.

17. A communication system comprising a personal communication device, the personal communication device comprising a memory in which is stored a secret, and a digital device capable of communication with the personal communication device, the personal communication device being configured whereby upon the digital device requesting a secret from the personal communication device, the personal communication device requests confirmation from a user that the secret can be provided and provides the secret to the digital device only if the confirmation is provided by the user.

18. A communication system according to claim 17, in which the communication capable of being established between the personal communication device and the digital device is wireless communication.

19. A communication system according to claim 17, in which the secret is encrypted in the memory and the digital device is capable of decrypting the secret.

20. A communication system according to claim 19, in which the secret is encrypted according to a key provided by the digital device.

21. A communication system according to claim 17, in which the confirmation comprises the user providing a secret.

22. A communication system according to claim 17, in which to request the secret, the digital device is configured to establish contact with the personal communication device and the personal communication device is configured to indicate to the user that a request for a secret has been received.

23. A communication system according to claim 22, in which the indication comprises providing an audible signal.

24. A communication system according to claim 22, in which the indication comprises providing a visual signal.

25. A communication system according to claim 17, in which the personal communication device is configured whereby upon receipt of the request the personal communication device provides to the user a selection of options of which at least one is to approve the request by selecting the relevant option.

26. A communication system according to claim 17, in which the memory stores a plurality of secrets and the personal communication device is configured to provide a user with a plurality of secrets from which to select the secret to be provided to the digital device.

27. A communication system according to claim 17, in which the personal communication device comprises a cellular communication device.

28. A communication system according to claim 27, in which the personal communication device comprises a cellular telephone for voice calls.

29. A communication system according to claim 17, in which the digital device is a non-cellular device.

30. A communication system according to claim 17, in which the digital device comprises a modem for communication with the personal communication device.

31. A communication system comprising a personal communication device, the personal communication device comprising a memory in which is stored a secret, and a digital device capable of communication with the personal communication device, the personal communication device being configured whereby upon the digital device establishing communications with the personal communication device and the digital device requesting a secret from the personal communication device, the personal communication device is configured to indicate to the user that a request for a secret has been received and the personal communication device is configured to request confirmation from a user that the secret can be provided and provides the secret to the digital device only if the confirmation is provided by the user.

32. A communication system comprising a personal communication device, the personal communication device comprising a memory in which is stored a secret, and a digital device capable of communication with the personal communication device, the personal communication device being configured whereby upon the digital device requesting a secret from the personal communication device, the personal communication device requests confirmation from a user that the secret can be provided by providing to the user a selection of options of which at least one is to approve the request by selecting the relevant option and provides the secret to the digital device only if the confirmation is provided by the user.

33. A personal communication device, the personal communication device comprising a memory in which is stored a secret, the personal communication device being configured whereby upon receipt of a request for a secret from the personal communication device, the personal communication device requests confirmation from a user that the secret can be provided and transmits the secret only if the confirmation is provided by the user.

34. A personal communication device according to claim 33, in which the transmission is by wireless communication.

35. A personal communication device according to claim 33, in which the secret is encrypted in the memory.

36. A personal communication device according to claim 35, in which the secret is encrypted according to a key provided by the digital device.

37. A personal communication device according to claim 33, in which the confirmation comprises the user providing a secret.

38. A personal communication device according to claim 33, in which the personal communication device is configured whereby upon receipt of a request for a secret, the personal communication device indicates to the user that a request for a secret has been received.

39. A personal communication device according to claim 38, in which the indication comprises providing an audible signal.

40. A personal communication device according to claim 38, in which the indication comprises providing a visual signal.

41. A personal communication device according to claim 33, in which the personal communication device is configured whereby the user is provided with a selection of options of which at least one is to approve the request by selecting the relevant option.

42. A personal communication device according to claim 33, in which the memory stores a plurality of secrets and the personal communication device is configured to provide a user with a plurality of secrets from which to select the secret to be transmitted.

43. A personal communication device according to claim 33, in which the personal communication device comprises a cellular communication device.

44. A personal communication device according to claim 43, in which the personal communication device comprises a cellular telephone for voice calls.

45. A personal communication device, the personal communication device comprising a memory in which is stored a secret, the personal communication device being configured whereby upon receipt of a request for a secret from the personal communication device, the personal communication device requests confirmation from a user that the secret can be provided and transmits the secret only if the confirmation is provided by the user the personal communication device further comprising indicating apparatus whereby upon receipt of a request for a secret, the personal communication device indicates to the user that a request for a secret has been received.

46. A personal communication device, the personal communication device comprising a memory in which is stored a secret, the personal communication device being configured whereby upon receipt of a request for a secret from the personal communication device, the personal communication device requests confirmation from a user that the secret can be provided by providing the user with a selection of options of which at least one is to approve the request by selecting the relevant option and the personal communication device transmits the secret only if the confirmation is provided by the user.
